(19) United States
(12) Patent Application Publication
(10) Pub. No.: US 2013/0111918 A1
(43) Pub. Date: May 9, 2013

(54) COMBUSTOR ASSEMBLY FOR A GAS TURBOMACHINE

(71) Applicants: Atanu Kumar Kundu, Bankura (IN); Karim Hasan, Simpsonville, SC (US); Arjun Singh, Rewa (IN); Krishna Kumar Venkataraman, Simpsonville, SC (US)

(72) Inventors: Atanu Kumar Kundu, Bankura (IN); Karim Hasan, Simpsonville, SC (US); Arjun Singh, Rewa (IN); Krishna Kumar Venkataraman, Simpsonville, SC (US)

(73) Assignee: GENERAL ELECTRIC COMPANY, Schenectady, NY (US)

(21) Appl. No.: 13/290,391

(22) Filed: Nov. 7, 2011

(51) Int. Cl. F02C 7/22; F02C 1/00

(52) U.S. Cl. 60/776; 60/740; 60/746

(57) ABSTRACT

A turbomachine combustor assembly includes a combustor housing, a first combustion zone arranged in the combustor housing, a second combustion zone arranged downstream from the first combustion zone, and one or more injector assemblies positioned downstream from the first combustion zone and upstream from the second combustion zone. The one or more injector assemblies includes a first injector member having a first centerline axis and a second injector member having a second centerline axis. The second injector member extends though the first injector member with the second centerline axis being off-set from the first centerline axis.

### BACKGROUND OF THE INVENTION

The subject matter disclosed herein relates to the art of turbomachines and, more particularly, to a combustor assembly for a gas turbomachine.

In general, gas turbomachines combust a fuel/air mixture that releases heat energy to form a high temperature gas stream. The high temperature gas stream is channeled to a turbine portion via a hot gas path. The turbine portion converts thermal energy from the high temperature gas stream to mechanical energy that rotates a turbine shaft. The turbine portion may be used in a variety of applications, such as for providing power to a pump or an electrical generator.

Turbomachine efficiency increases as combustion gas stream temperatures increase. Unfortunately, higher gas stream temperatures produce higher levels of nitrogen oxide (NOx), an emission that is subject to both federal and state regulation. Therefore, there exists a careful balancing act between operating gas turbomachines in an efficient range, while also ensuring that the output of NOx remains below federal and state mandated levels. One method of achieving low NOx levels is to ensure good mixing of fuel and air prior to combustion, and providing an environment that leads to more complete combustion of the fuel/air mixture.

### BRIEF DESCRIPTION OF THE INVENTION

According to one aspect of the exemplary embodiment, a turbomachine combustor assembly includes a combustor housing, a first combustion zone arranged in the combustor housing, a second combustion zone arranged downstream from the first combustion zone, and one or more injector assemblies positioned downstream from the first combustion zone and upstream from the second combustion zone. The one or more injector assemblies includes a first injector member having a first centerline axis and a second injector member having a second centerline axis. The second injector member extends though the first injector member with the second centerline axis being off-set from the first centerline axis.

According to another aspect of the exemplary embodiment, a turbomachine includes a compressor portion, a turbine portion operatively connected to the compressor portion, and a combustor assembly fluidly linking the compressor portion and the turbine portion. The combustor assembly includes a combustor housing, a first combustion zone arranged in the combustor housing, a second combustion zone arranged downstream from the first combustion zone, and one or more injector assemblies positioned downstream from the first combustion zone and upstream from the second combustion zone. The one or more injector assemblies includes a first injector member having a first centerline axis and a second injector member having a second centerline axis. The second injector member extends though the first injector member with the second centerline axis being off-set from the first centerline axis.

According to yet another aspect of the exemplary embodiment, a method of combusting a fluid in a turbomachine combustor assembly includes combusting a first combustible mixture in a first combustion zone arranged in the combustor assembly, introducing a first portion of a second combustible mixture downstream from the first combustion zone through a first injector member of an injector assembly, introducing a second portion of the second combustible mixture upstream from a substantial portion of the first portion of the combustible mixture through a second injector member of the injector assembly. The second injector member extends through and is axially off-set relative to the first injector member.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic diagram of a turbomachine including a combustor assembly having an injector assembly in accordance with an exemplary embodiment;

FIG. 2 is a partial cross-sectional view of the combustor assembly of FIG. 1 in accordance with one aspect of the exemplary embodiment;

FIG. 3 is a partial perspective view of the injector assembly in accordance with an exemplary embodiment;

FIG. 4 is a partial cross-sectional view of the combustor assembly of FIG. 1 in accordance with another aspect of the exemplary embodiment;

FIG. 5 is a partial cross-sectional view of the combustor assembly of FIG. 1 in accordance with still another aspect of the exemplary embodiment; and

FIG. 6 is a partial cross-sectional view of the combustor assembly of FIG. 1 in accordance with still another aspect of the exemplary embodiment.

The detailed description explains embodiments of the invention, together with advantages and features, by way of example with reference to the drawings.

### DETAILED DESCRIPTION OF THE INVENTION

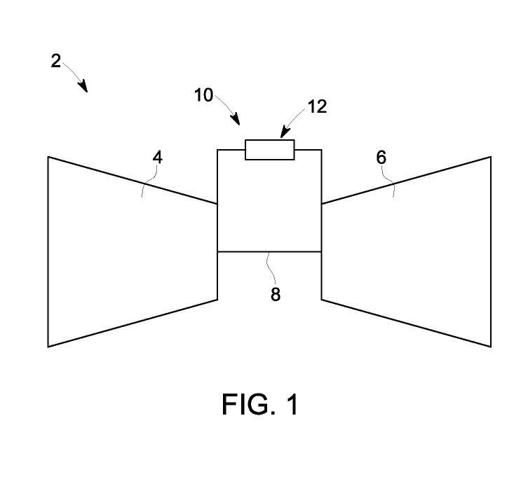

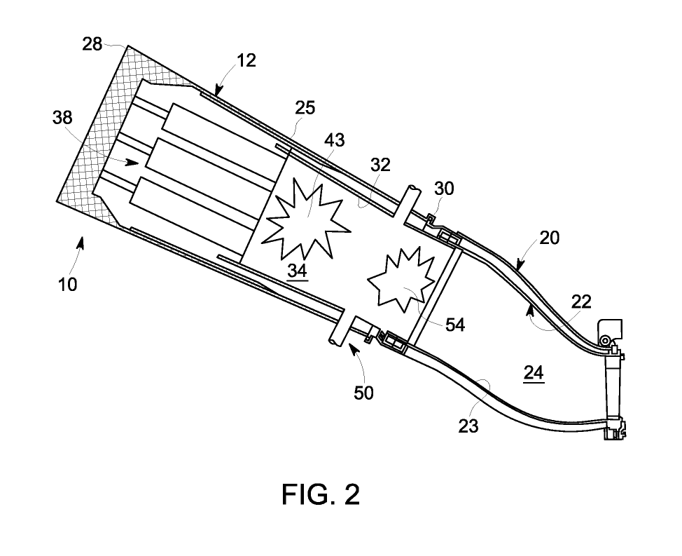

With reference to FIGS. 1 and 2, a turbomachine constructed in accordance with an exemplary embodiment is indicated generally at 2. Turbomachine 2 includes a compressor portion 4 operatively coupled to a turbine portion 6 through a common compressor/turbine shaft or rotor 8. Compressor portion 4 is also fluidly connected to turbine portion 6 via a combustor assembly 10 having a combustor housing 12. In the exemplary embodiment shown, combustor assembly 10 is linked to turbine portion 6 through a transition piece 20. Transition piece 20 includes a liner 22 having an inner surface 23 that defines a duct 24. Duct 24 delivers products of combustion from combustor assembly 10 into a hot gas path (not shown) and toward a first stage (also not shown) of turbine portion 6.

As further shown in FIG. 2, combustor housing 12 includes an outer wall 25 that extends from a first end 28 to a second end 30 that is coupled to transition piece 20. Combustor housing 12 is also shown to include an inner wall 32 that defines a combustion chamber 34. Combustor assembly 10 includes a plurality of injector members or nozzles indicated generally at 38 that guide a combustible mixture into combustion chamber 34. The combustible mixture from injector members 38 is combusted in a first combustion zone 43 to form hot gases that flow through duct 24 of transition piece 20 toward turbine portion 6. Combustor assembly 10 also includes a plurality of injector assemblies, one of which is indicated at 50, arranged downstream from injector members 38 and first combustion zone 43 and extend through combustor housing 12. In the exemplary embodiment shown, injector assembly 50 delivers a second combustible mixture into combustion chamber 34 that is combusted in a second combustion zone 54 arranged downstream from first combustion zone 43. Combustion gases formed in second combustion zone 54 combine with combustion gases formed in first combustion zone 43 and flow towards turbine portion 6. The combustion of the second combustible mixture not only forms additional products of combustion but also facilitates combustion of any uncombusted products passing from first combustion zone 43.

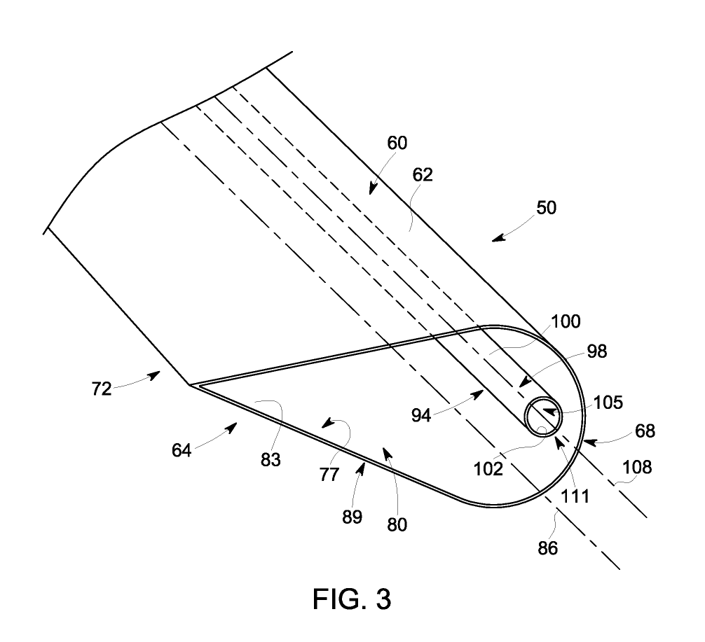

As best shown in FIG. 3, injection assembly 50 includes a main body 60 having an outer surface 62 having an aerodynamic profile that defines an airfoil 64. Airfoil 64 includes a leading edge 68 and a trailing edge 72. In the exemplary embodiment shown, main body 60 also includes an inner surface 77 that defines a central passage 80 that establishes a first injector member 83. First injector member 83 includes a centerline axis 86 that extends radially relative to combustor housing 12 through main body 60. First injector member 80 is further shown to include an outlet section 89 that delivers a first fluid, such as air, toward second combustion zone 54. at this point, it should be understood that the particular orientation of injector assembly 50 relative to combustor assembly 10 could vary.

Injector member 50 also includes a second injector member 94 that extends through central passage 80 off-set relative to centerline axis 86. Second injector member 94 includes a body 98 having an outer surface 100 and an inner surface 102 that defines a central conduit 105 having a centerline axis 108. Central conduit 105 includes an outlet portion 111 that, in the exemplary embodiment shown, is substantially coplanar with outlet section 89 of first injector member 83. Of course it should be understood that the relative positioning of outlet portion 111 and outlet section 89 could vary. As discussed above, second injector member 94 is off-set relative to centerline axis 86 of first injector member 83. In the exemplary embodiment shown, second injector member 94 is arranged at leading edge 68. With this arrangement, a second fluid, such as a fuel, is introduced slightly upstream from a majority of the first fluid. The particular introduction point of the second fluid relative to the first fluid produces more complete mixing of the fluids which, in turn, leads to more complete combustion. In addition, the particular positioning of second injector member 94 relative to first injector member 83 reduces localized metal temperature gradients and pressure drops of the combustion gases.

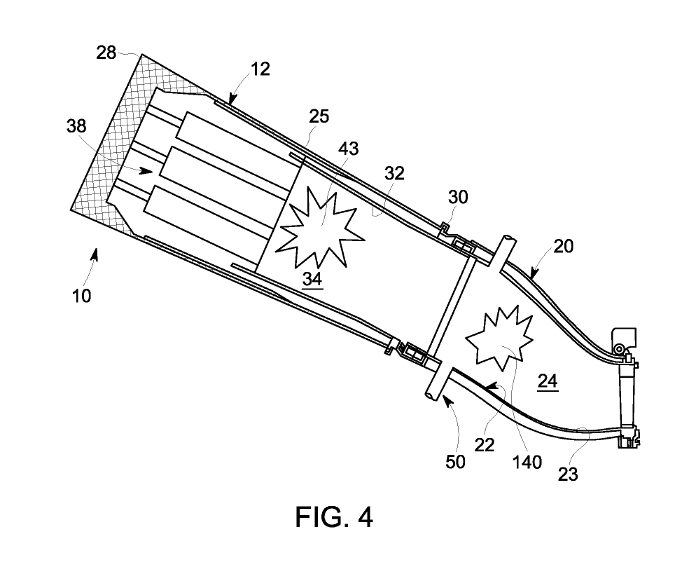

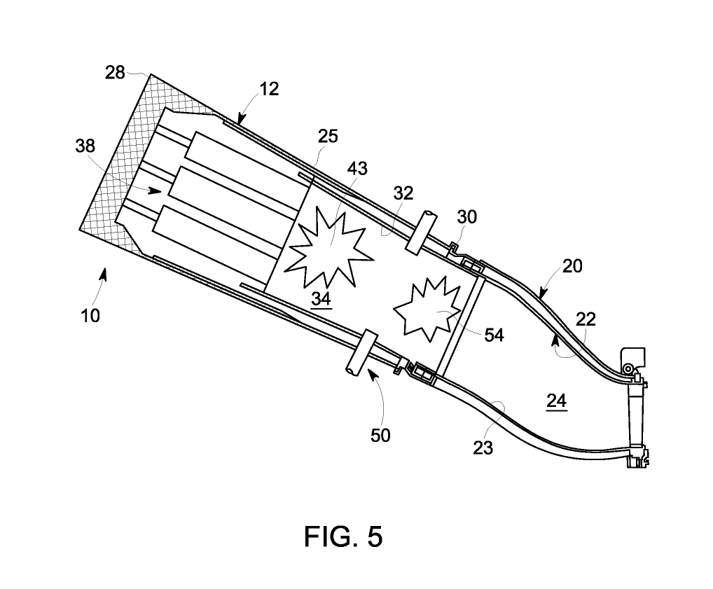

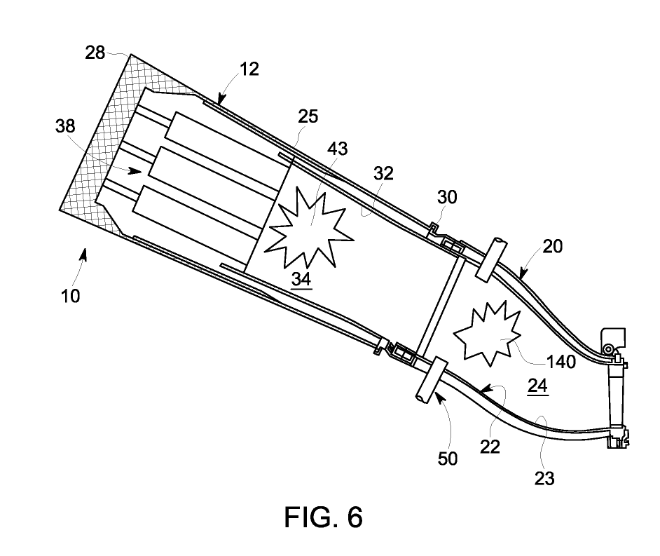

At this point it should be understood that the exemplary embodiments provide a system for combusting combustible mixtures in a turbomachine. More specifically, the exemplary embodiments disclose an injector assembly having an airfoil shaped profile that establishes a first injector member and provides space for a second, upstream injector member. The particular geometry of the injector members allows for more complete mixing of the combustible mixture to reduce certain combustion byproducts such as NOx. Reducing certain combustion byproducts provides enhanced turndown capacity for the turbomachine. In addition, the relative positioning of the first and second injector members leads to reduced thermal gradients so as to improve component life. Also, while shown arranged in combustor housing 12, it should be understood that injector assembly 50 could also be arranged in transition piece 20 such as shown in FIG. 4 wherein like reference numbers represent corresponding parts in the respective views. In FIG. 4 injector assembly 50 establishes a second combustion zone 140 within duct 24. The particular location of injector assembly 50 can vary depending upon desired operational requirements. Further, it should be understood that the number of injector assemblies can vary. It should be further understood that injector assembly 50 could partially extend into combustion chamber 34 such as shown in FIG. 5 wherein like reference numbers represent corresponding parts. It should be understood that injector assembly 50 could also be positioned to partially extend into transition piece 20 such as shown in FIG. 6.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A turbomachine combustor assembly comprising:
a combustor housing;
a first combustion zone arranged in the combustor housing;
a second combustion zone arranged downstream from the first combustion zone; and
one or more injector assemblies positioned downstream from the first combustion zone and upstream from the second combustion zone, the one or more injector assemblies including a first injector member having a first centerline axis and a second injector member having a second centerline axis, the second injector member extending though the first injector member with the second centerline axis being off-set from the first centerline axis.

2. The turbomachine combustor assembly according to claim 1, wherein the first injector member includes an aerodynamic profile defining an airfoil having a leading edge and a trailing edge.

3. The turbomachine combustor assembly according to claim 2, wherein the second injector member is arranged at the leading edge of the airfoil.

4. The turbomachine combustor assembly according to claim 1, wherein the one or more injector assemblies is arranged in the combustor housing.

5. The turbomachine combustor assembly according to claim 4, wherein the one or more injector assemblies includes an outlet arranged to be substantially flush with an inner surface of the combustor housing.

6. The turbomachine combustor assembly according to claim 1, further comprising: a transition piece coupled to the combustor housing, the transition piece including a liner defining a duct, the second combustion zone being arranged in the duct.

7. The turbomachine combustor assembly according to claim 6, wherein the one or more injector assemblies is arranged at the transition piece.

8. The turbomachine combustor assembly according to claim 7, wherein the one or more injector assemblies includes an outlet arranged to be substantially flush with an inner surface of the liner.

9. The turbomachine combustor assembly according to claim 6, wherein the one or more injector assemblies extends partially through one of the combustor housing and the liner.

10. A turbomachine comprising:
a compressor portion;
a turbine portion operatively connected to the compressor portion; and
a combustor assembly fluidly linking the compressor portion and the turbine portion, the combustor assembly comprising:
a combustor housing;
a first combustion zone arranged in the combustor housing;
a second combustion zone arranged downstream from the first combustion zone; and
one or more injector assemblies positioned downstream from the first combustion zone and upstream from the second combustion zone, the one or more injector assemblies including a first injector member having a first centerline axis and a second injector member having a second centerline axis, the second injector member extending though the first injector member with the second centerline axis being off-set from the first centerline axis.

11. The turbomachine according to claim 10, wherein the first injector member includes an aerodynamic profile defining an airfoil having a leading edge and a trailing edge.

12. The turbomachine according to claim 11, wherein the second injector member is arranged at the leading edge of the airfoil.

13. The turbomachine according to claim 10, wherein the one or more injector assemblies is arranged in the combustor housing.

14. The turbomachine according to claim 13, wherein the one or more injector assemblies includes an outlet arranged to be substantially flush with an inner surface of the combustor housing.

15. The turbomachine according to claim 10, further comprising a transition piece coupled to the combustor housing, the transition piece including a liner defining a duct, the second combustion zone being arranged in the duct.

16. The turbomachine according to claim 15, wherein the one or more injector assemblies is arranged at the transition piece.

17. The turbomachine according to claim 16, wherein the one or more injector assemblies includes an outlet arranged to be substantially flush with an inner surface of the liner.

18. The turbomachine according to claim 15, wherein the one or more injector assemblies partially extends into one of the combustor housing and the liner.

19. A method of combusting a fluid in a turbomachine combustor assembly, the method comprising:
combusting a first combustible mixture in a first combustion zone arranged in the combustor assembly;
introducing a first portion of a second combustible mixture downstream from the first combustion zone through a first injector member of an injector assembly;
introducing a second portion of the second combustible mixture upstream from a substantial portion of the first portion of the combustible mixture through a second injector member of the injector assembly, the second injector member extending through and being axially off-set relative to the first injector member.

20. The method of claim 19, wherein introducing the first portion of the second combustible mixture through the first injector member includes passing the first portion of the second combustible mixture through an injector member having an aerodynamic profile.
